(19) United States
(12) Patent Application Publication
(10) Pub. No.: US 2025/0070469 A1
(43) Pub. Date: Feb. 27, 2025

(54) ANTENNA DEVICE AND IC CARD HAVING THE SAME

(71) Applicant: TDK Corporation, Tokyo (JP)

(72) Inventors: Shoma KAJIKIYA, Tokyo (JP); Tomohiro MORIKI, Tokyo (JP)

(73) Assignee: TDK Corporation, Tokyo (JP)

(21) Appl. No.: 18/810,721

(22) Filed: Aug. 21, 2024

(30) Foreign Application Priority Data
Aug. 24, 2023 (JP) 2023-136023

(51) Int. Cl. H01Q 7/00; G06K 19/07; G06K 19/077

(52) U.S. Cl. CPC H01Q 7/00; G06K 19/0723; G06K 19/0779

(57) ABSTRACT

Disclosed herein is an antenna device that includes a magnetic body having a through hole, and a coil pattern including a first winding part and a second winding part overlapping the through hole of the magnetic body. The through hole of the magnetic body includes first and third inner peripheral edges each including a section extending in a first direction and positioned opposite to each other and second and fourth inner peripheral edges each including a section extending in a second direction perpendicular to the first direction and positioned opposite to each other. The second winding part includes an inner peripheral side part wound along the first to fourth inner peripheral edges and an outer peripheral side part positioned outside the inner peripheral side part and wound along the second to fourth inner peripheral edges without being along the first inner peripheral edge.

### CROSS-REFERENCE TO RELATED APPLICATION

This application claims the benefit of Japanese Patent Application No. 2023-136023, filed on Aug. 24, 2023, the entire disclosure of which is incorporated by reference herein.

### BACKGROUND

The present disclosure relates to an antenna device and an IC card having the same.

U.S. Patent Publication No. 2015/0235122 discloses, in FIG. 4A, an antenna device having a booster antenna wound in a plurality of turns and a coupler coil connected to the turns of the booster antenna and wound in a plurality of turns in a direction opposite to the winding direction of the booster antenna.

However, the configuration of U.S. Patent Publication No. 2015/0235122 fails to provide sufficient magnetic coupling between the coupler coil and a module antenna of a chip module.

### SUMMARY

An antenna device according to an embodiment of the present disclosure includes a magnetic body having a through hole and a coil pattern. The coil pattern includes a first winding part wound in a plurality of turns along the outer edge of the magnetic body and a second winding part connected to respective turns of the first winding part and wound in a plurality of turns in a direction opposite to the winding direction of the first winding part so as to overlap the through hole of the magnetic body. The through hole of the magnetic body includes first and third inner peripheral edges each including a section extending in a first direction and positioned opposite to each other and second and fourth inner peripheral edges each including a section extending in a second direction perpendicular to the first direction and positioned opposite to each other. The second winding part includes an inner peripheral side part wound along the first, second, third, and fourth inner peripheral edges and an outer peripheral side part positioned outside the inner peripheral side part and wound along the second, third, and fourth inner peripheral edges without being along the first inner peripheral edge.

### BRIEF DESCRIPTION OF THE DRAWINGS

The above features and advantages of the present disclosure will be more apparent from the following description of certain embodiments taken in conjunction with the accompanying drawings, in which:

FIG. 1 is a schematic perspective view illustrating the outer appearance of an IC card 3 having an antenna device according to an embodiment of the present disclosure;

FIG. 2 is a schematic exploded perspective view for explaining the structure of the IC card 3;

FIG. 3 is a schematic cross-sectional view for explaining the structure of the IC card 3;

FIG. 4A is a schematic enlarged view of an area B shown in FIG. 3;

FIG. 4B shows a state in which a substrate 71 is added to the structure shown in FIG. 4A;

FIG. 4C shows a state in which an adhesive layer 62 and substrates 71 and 72 are added to the structure shown in FIG. 4A;

FIG. 5 is a schematic enlarged view of a modification of the area B shown in FIG. 3;

FIG. 6 is a schematic plan view for explaining the configuration of the antenna device 1;

FIG. 7 is a schematic perspective view of the IC module 50 as viewed from the back surface side thereof;

FIG. 8 is a schematic diagram showing a state in which the IC card 3 and the card reader 6 communicate with each other;

FIG. 9 is a schematic plan view for explaining the configuration of an antenna device 1A according to a first modification;

FIG. 10 is a schematic plan view for explaining the configuration of an antenna device 1B according to a second modification;

FIG. 11 is a schematic plan view for explaining the configuration of an antenna device 1C according to a third modification;

FIG. 12 is a schematic cross-sectional view for explaining a mechanism in which capacitance can be obtained by the capacitor electrode pattern 200; and

FIG. 13 is a schematic plan view for explaining the configuration of an antenna device 1D according to a fourth modification.

### DETAILED DESCRIPTION OF THE EMBODIMENTS

An object of the present disclosure is to provide an antenna device having improved communication characteristics.

Some embodiments of the present disclosure will be explained below in detail with reference to the accompanying drawings.

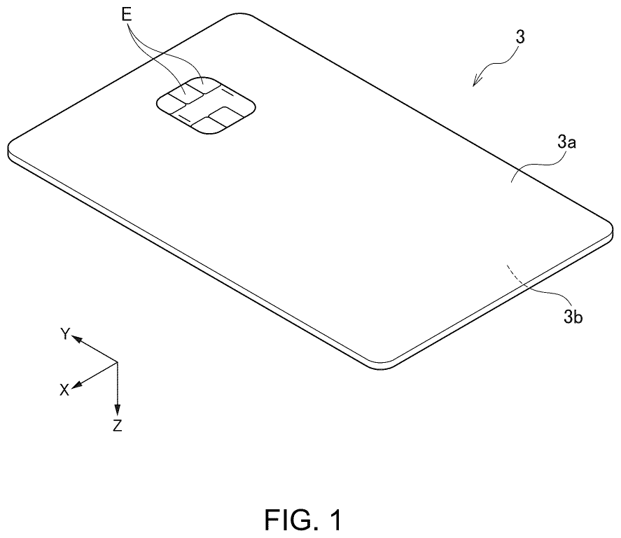

FIG. 1 is a schematic perspective view illustrating the outer appearance of an IC card 3 having an antenna device according to an embodiment of the present disclosure.

As illustrated in FIG. 1, the IC card 3 according to the present embodiment has a plate-like shape in which the Y—, X—, and Z-directions are defined as the longer length direction, shorter length direction, and thickness direction, respectively, and has an upper surface 3a and a back surface 3b which constitute the XY surface. The IC card 3 incorporates therein an IC module to be described later whose terminal electrode E is exposed to the upper surface 3a of the IC card 3.

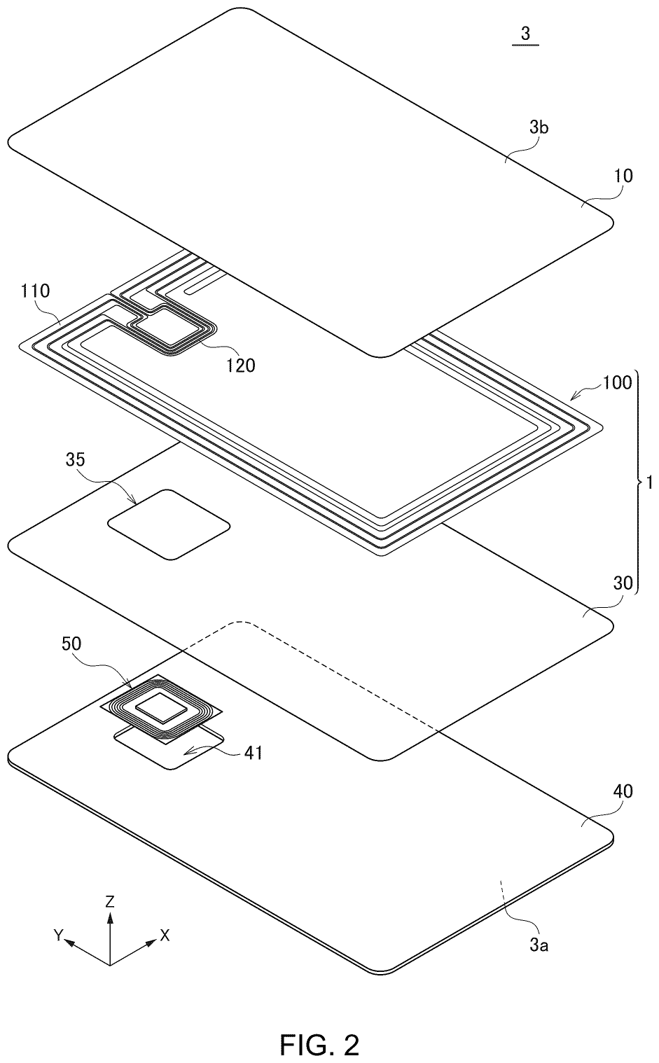

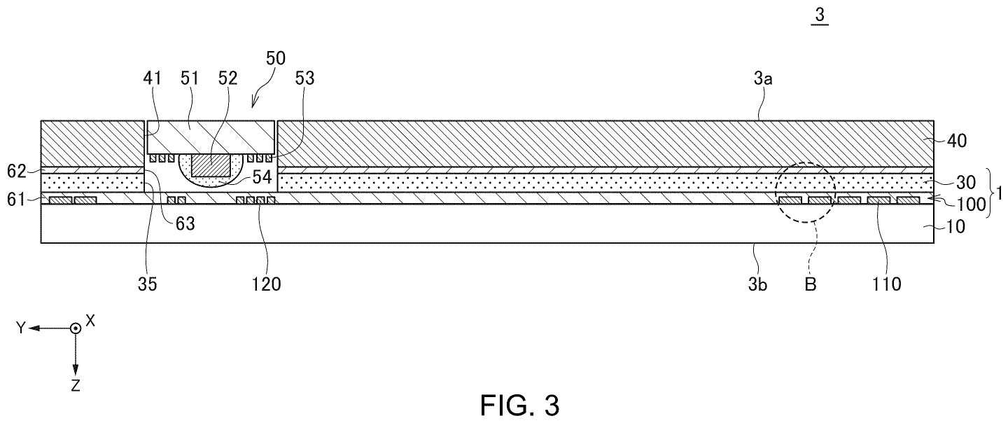

FIGS. 2 and 3 are respectively a schematic exploded perspective view and a schematic cross-sectional view for explaining the structure of the IC card 3 having an antenna device 1 according to the present embodiment.

The IC card 3 illustrated in FIGS. 2 and 3 has a structure in which a plastic plate 10, an adhesive layer 61 with a coil pattern 100 embedded therein, a magnetic body 30, an adhesive layer 62, and a metal plate 40 are laminated in this order from the back surface 3b side to the upper surface 3a side. The antenna device 1 according to the present embodiment is constituted by the coil pattern 100 and the magnetic body 30 covering the coil pattern 100. The magnetic body 30, metal plate 40, and adhesive layer 62 respectively have through holes 35, 41, and 63. The through holes 35, 41, and 63 overlap one another in the Z-direction (lamination direction).

The plastic plate 10 is made of a resin material not preventing transmission of magnetic flux. The outer surface of the plastic plate 10 constitutes the back surface 3b of the IC card 3. The metal plate 40 is made of a metal material such as stainless steel or titanium. The outer surface of the metal plate 40 constitutes the upper surface 3a of the IC card 3. The metal plate 40 has a through hole 41 formed therein, in which an IC module 50 is disposed. As described above, the IC card 3 is a card that uses a metal plate as the main body thereof. The plane position of the inner peripheral edge of the through hole 41 may substantially coincide with the those of the inner peripheral edges of the through holes 35 and 63.

The plastic plate 10 is covered with the magnetic body 30 through the adhesive layer 61 and the coil pattern 100 embedded therein. Although details will be described later, the coil pattern 100 includes a first winding part 110 and a second winding part 120. Examples of the material of the adhesive layer 61 include an acrylic-based binder resin, a material prepared by mixing a ceramic material in the acrylic-based binder resin, or the like. On the other hand, examples of the material of the adhesive layer 62 include an acrylic-based double-sided tape, an acrylic-based binder resin, a thermosetting resin, a thermoplastic resin, or the like, as well as a material prepared by mixing a ceramic material in the acrylic-based binder resin.

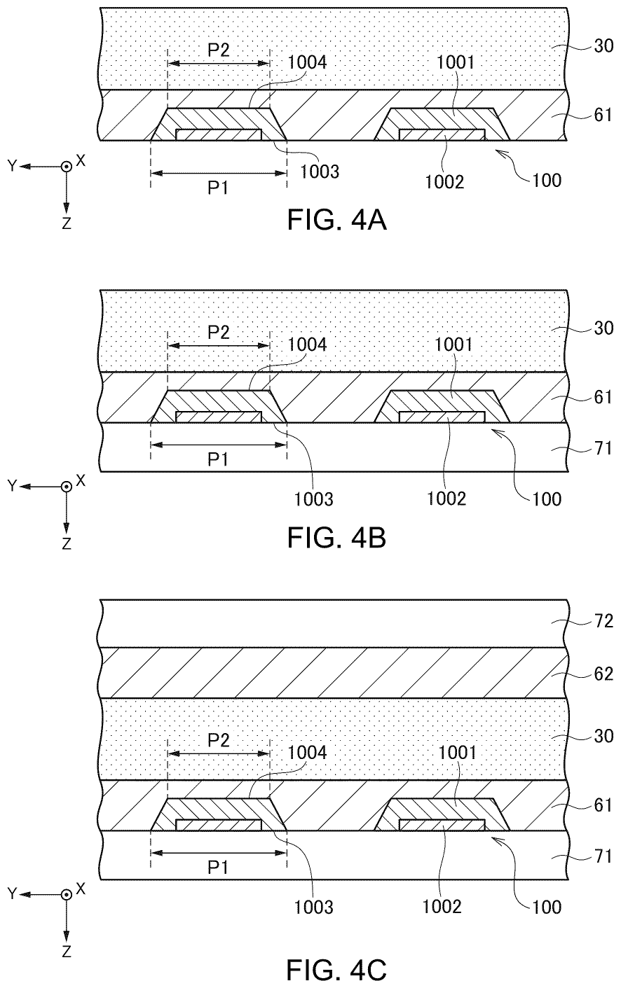

FIG. 4A is a schematic enlarged view of an area B denoted by a dashed circle in FIG. 3, which illustrates a state before the antenna device 1 according to the present embodiment is stuck to the plastic plate 10 and metal plate 40.

In the example illustrated in FIG. 4A, the coil pattern 100 is constituted of a main body part 1001 made of a good conductor such as copper (Cu) and a seed part 1002 made of a conductive resin material. The coil pattern 100 having such a configuration can be manufactured, as illustrated in FIG. 4B, by forming the seed part 1002 on the surface of a substrate 71 made of PET (Polyethylene Terephthalate) or PI (Polyimide) and then forming the main body part 1001 through electrolytic plating using the seed part 1102 as a feed conductor. Then, the adhesive layer 61 is formed on the surface of the substrate 71 so as to embed therein the coil pattern 100, followed by sticking of the magnetic body 30 and peeling of the substrate 71, whereby the structure illustrated in FIG. 4A can be obtained. The magnetic body 30 may be a sheet-like member or a coated body coated onto the surface of the adhesive layer 61. The substrate 71 may be peeled immediately before sticking of the antenna device 1 according to the present embodiment to the plastic plate 10. This facilitates handling of the antenna device 1.

In the example illustrated in FIG. 4A, the pattern width of the coil pattern 100 decreases toward the magnetic body 30. Accordingly, a pattern width P2 of the coil pattern 100 at its upper surface 1004 is smaller than a pattern width P1 of the coil pattern 100 at its bottom surface 103 positioned opposite to the upper surface 1004 so as to be exposed from the adhesive layer 61. By making the coil pattern 100 having such a cross-sectional shape, filling performance of the adhesive layer 61 between turns of the coil pattern can be improved.

Alternatively, as illustrated in FIG. 4C, it is possible to provide another substrate 72 on the upper surface of the magnetic body 30 through the adhesive layer 62 and peel the substrates 71 and 72 immediately before sticking of the antenna device 1 according to the present embodiment to the plastic plate 10 and metal plate 40. This facilitates the handling of the antenna device 1 and the assembly of the IC card 3 including the antenna device 1.

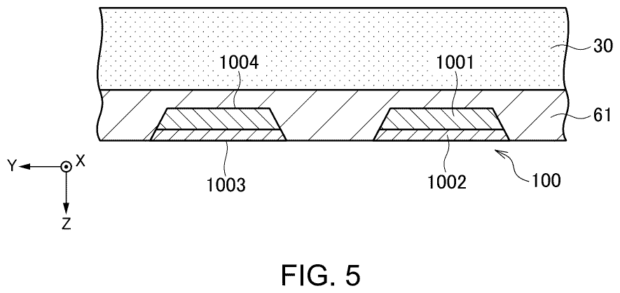

FIG. 5 is a schematic enlarged view of a modification of the area B, which illustrates a state before the antenna device 1 according to the present embodiment is stuck to the plastic plate 10 and metal plate 40.

The example illustrated in FIG. 5 differs in structure from the example illustrated in FIG. 4A in that the entire bottom surface 1003 of the coil pattern 100 is constituted of the seed part 1002 and that the main body part 1001 is not exposed. That is, the seed part 1002 is exposed from the surface of the adhesive layer 61, whereas the main body part 1001 is embedded in the adhesive layer 61 without being exposed from the surface of the adhesive layer 61. With this configuration, when a colored (e.g., black) conductive resin material is used as the material of the seed part 1002, a color change, if occurs in the main body part 1001 made of a good conductor such as copper (Cu) is hidden by the colored seed part 1002, poor appearance becomes visually inconspicuous.

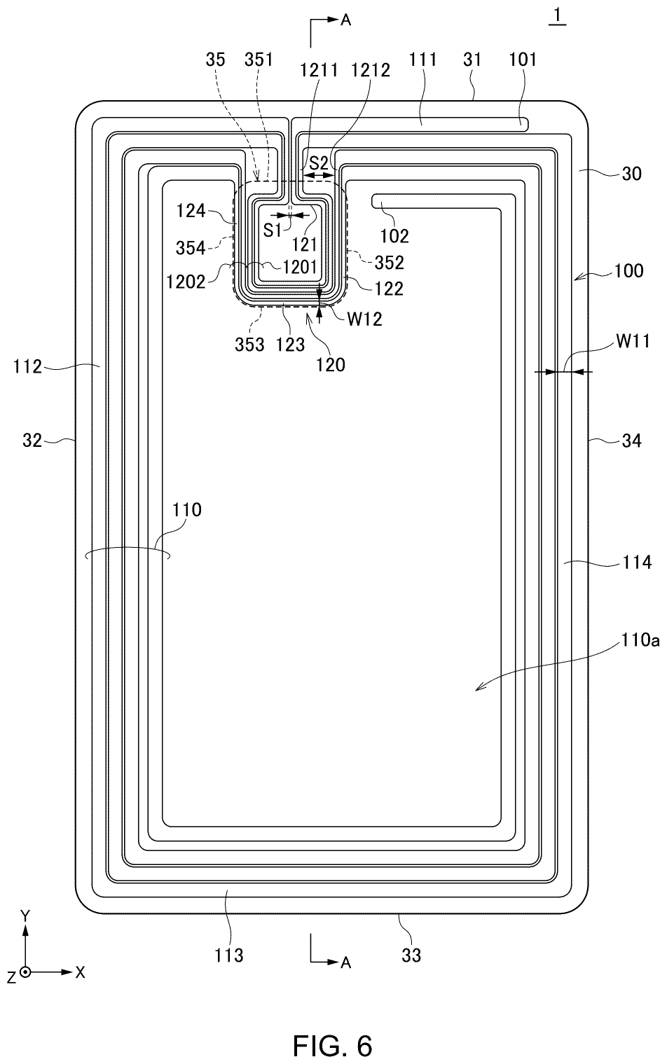

FIG. 6 is a schematic plan view for explaining the configuration of the antenna device 1 according to the present embodiment. The line A-A illustrated in FIG. 6 indicates the sectional position of FIG. 3.

As illustrated in FIG. 6, the coil pattern 100 included in the antenna device 1 according to the present embodiment includes a first winding part 110 wound in a plurality of turns along the outer edge of the magnetic body 30 so as to overlap the magnetic body 30 and a second winding part 120 connected to the turns of the first winding part 110 and wound in a plurality of turns so as to overlap the through hole 35 of the magnetic body 30. The second winding part 120 overlaps, in the Z-direction, the IC module 50 disposed in the through hole 41 of the metal plate 40.

In the example illustrated in FIG. 6, the first and second winding parts 110 and 120 are each wound in four turns. The second winding part 120 protrudes toward an opening 110a of the first winding part 110. That is, each of the turns constituting the coil pattern 100 includes the first winding part 110 of less than one turn and the second winding part 120 of less than one turn.

The first winding part 110 functions as an antenna coil coupled to an external card reader in actual use state. The second winding part 120 functions as a coupling coil coupled to the IC module 50. The second winding part 120 may function as a part of the antenna coil coupled to the external card reader. A pattern width W11 of the first winding part 110 may be larger than a pattern width W12 of the second winding part 120. This can reduce the DC resistance of the first winding part 110 and sufficiently ensure the opening size of the second winding part 120. When the pattern width of the first winding part 110 is not uniform, the pattern width W11 may be defined by the maximum pattern width, the minimum pattern width, or the average pattern width of the first winding part 110. Similarly, when the pattern width of the second winding part 120 is not uniform, the pattern width W12 may be defined by the maximum pattern width, the minimum pattern width, or the average pattern width of the second winding part 120.

When an outer peripheral end 101 of the coil pattern 100 is set as a start point, and an inner peripheral end 102 of the coil pattern 100 is set as an end point, the first winding part 110 is wound left-handed (counterclockwise), and the second winding part 120 is wound right-handed (clockwise). That is, the first and second winding parts 110 and 120 are wound in mutually opposite directions.

The magnetic body 30 has first and third outer edges 31 and 33 extending in the X-direction and positioned on opposite sides and second and fourth outer edges 32 and 34 extending in the Y-direction and positioned on opposite sides. The first winding part 110 of the coil pattern 100 has a first section 111 extending in the X-direction along the first outer edge 31 of the magnetic body 30, a second section 112 extending in the Y-direction along the second outer edge 32 of the magnetic body 30, a third section 113 extending in the X-direction along the third outer edge 33 of the magnetic body 30, and a fourth section 114 extending in the Y-direction along the fourth outer edge 34 of the magnetic body 30. When the outer peripheral end 101 and the inner peripheral end 102 of the coil pattern 100 are set as the start point and the end point, respectively, the first winding part 110 is wound in the order of first section 111→second section 112→third section 113→ and fourth section 114. The second, third, and fourth sections 112, 113, and 114 are each constituted of a linearly extending, continuous conductor pattern, whereas the first section 111 is divided halfway and passes through the second winding part 120.

The through hole 35 of the magnetic body 30 has a substantially rectangular shape and has first and third inner peripheral edges 351 and 353 extending in the X-direction and positioned on opposite sides and second and fourth inner peripheral edges 352 and 354 extending in the Y-direction and positioned on opposite sides. However, the through hole 35 of the magnetic body 30 need not necessarily have a rectangular shape and may have a circular shape, for example. In this case, the first and third inner peripheral edges 351 and 353 may each be defined by a section including a portion extending in the X-direction, and the second and fourth inner peripheral edges 352 and 354 may each be defined by a section including a portion extending in the Y-direction. The second winding part 120 of the coil pattern 100 has a first section 121 extending in the X-direction along the first inner peripheral edge 351 of the magnetic body 30, a second section 122 extending in the Y-direction along the second inner peripheral edge 352 of the magnetic body 30, a third section 123 extending in the X-direction along the third inner peripheral edge 353 of the magnetic body 30, and a fourth section 124 extending in the Y-direction along the fourth inner peripheral edge 354 of the magnetic body 30.

As illustrated in FIG. 6, the second winding part 120 has an inner peripheral side part 1201 positioned on the inner peripheral side and an outer peripheral side part 1202 positioned outside the inner peripheral side part 1201. In the example illustrated in FIG. 6, the inner peripheral side part 1201 and outer peripheral side part 1202 are each wound in about two turns. When the outer and inner peripheral ends 101 and 102 of the coil pattern 100 are set as start and end points, respectively, the inner peripheral side part 1201 of the second winding part 120 is wound in the order of first half of first section 121→second section 122→third section 123→fourth section 124→second half of first section 121 along the half of the first inner peripheral edge 351, second inner peripheral edge 352, third inner peripheral edge 353, and fourth inner peripheral edge 354, and the remaining half of the first inner peripheral edge 351 of the through hole 35. On the other hand, the outer peripheral side part 1202 of the second winding part 120 is wound in the order of second section 122→third section 123→fourth section 124 along the inner peripheral edges (second, third, and fourth inner peripheral edges 352, 353, and 354) of the through hole 35 except the first inner peripheral edge 351. As described above, the outer peripheral side part 1202 of the second winding part 120 does not have the first section 121.

The direction of current flowing in the first section 111 of the first winding part 110 and the direction of current flowing in the first section 121 of the second winding part 120 are opposite to each other. Thus, when the first section 111 of the first winding part 110 and the first section 121 of the second winding part 120 are brought close to each other in the Y-direction, cancelling of magnetic fields may occur to deteriorate communication characteristics due to inductance reduction. However, in the present embodiment, the inner peripheral side part 1201 of the second winding part 120 includes the first section 121, whereas the outer peripheral side part 1202 of the same does not include the first section 121, thus ensuring a predetermined distance between the first section 111 of the first winding part 110 and the first section 121 of the second winding part 120 in the Y-direction. This can prevent communication characteristics from being deteriorated due to cancelling of magnetic fields.

The coil pattern 100 further has a first connection section 1211 extending in the Y-direction and connecting the first winding part 110 and the inner peripheral side part 1201 of the second winding part 120 and a second connection section 1212 extending in the Y-direction and connecting the first winding part 110 and the outer peripheral side part 1202 of the second winding part 120. The first connection section 1211 constituted of the turns densely disposed around the center portion in the X-direction of the through hole 35 crosses the first inner peripheral edge 351 of the through hole 35. On the other hand, the X-direction position of the second connection section 1212 is around the second inner peripheral edge 352 or fourth inner peripheral edge 354 of the through hole 35. Accordingly, a space width S2 along the first inner peripheral edge 351 of the through hole 35 between the first and second connection sections 1211 and 1212 adjacent in the X-direction is larger than a space width S1 along the first inner peripheral edge 351 of the through hole 35 between the first connection sections 1211 adjacent in the X-direction.

The area in the vicinity of the inner peripheral edge of the through hole 41 of the metal plate 40 has high magnetic field strength. In the present embodiment, since the space width S2 between the first and second connection sections 1211 and 1212 is sufficiently ensured, interference between a magnetic field around the inner peripheral edge of the through hole 41 of the metal plate 40 and the coil pattern 100 is reduced, thereby improving communication characteristics.

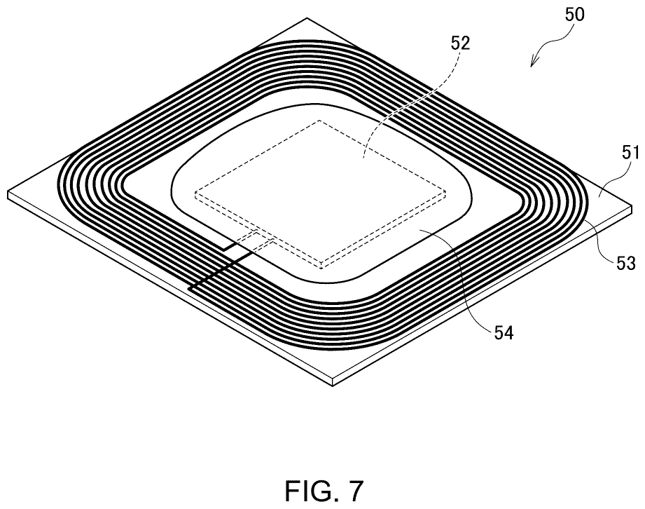

FIG. 7 is a schematic perspective view of the IC module 50 as viewed from the back surface side thereof.

As illustrated in FIG. 7, the IC module 50 includes a module substrate 51, an IC chip 52 mounted on or incorporated in the module substrate 51, and a coupling coil 53. The IC chip 52 is protected by being covered with a dome-shaped protective resin 54. The protective resin 54 is made of an insulating member. The terminal electrode E illustrated in FIG. 1 is provided on the front surface side of the module substrate 51. The IC module 50 thus configured is accommodated in the through hole 41 formed in the metal plate 40. In a state where the IC module 50 is accommodated in the through hole 41, the coupling coil 53 and second winding part 120 of the coil pattern 100 are electromagnetically coupled to each other. The second winding part 120 is connected to the first winding part 110 functioning an antenna coil, thus allowing the IC module 50 to communicate with an external device through the coil pattern 100.

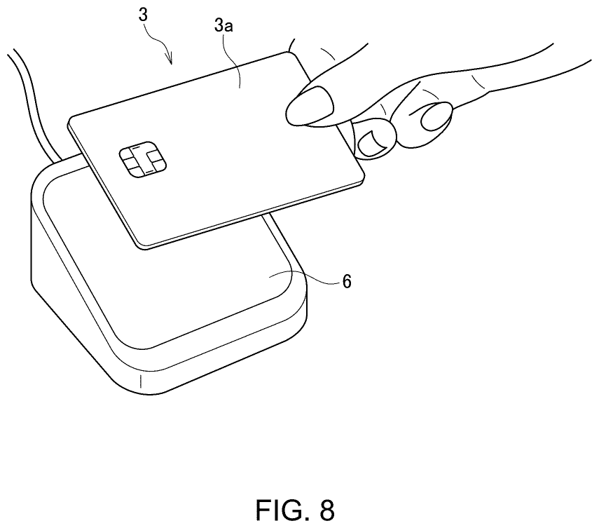

Thus, as illustrated in FIG. 8, when the back surface 3b of the IC card 3 is made to face a card reader 6, communication can be performed between the card reader 6 and the IC chip 52. That is, the card reader 6 is coupled to the coupling coil 53 of the IC module 50 through the coil pattern 100 and can thereby communicate with the IC chip 52.

As described above, the antenna device 1 according to the present embodiment has the following advantages. That is, the inner peripheral side part 1201 of the second winding part 120 of the coil pattern 100 is wound along the first to fourth inner peripheral edges 351, 352, 353, and 354 of the through hole 35 of the magnetic body 30 in the order mentioned, making it possible to increase inductance. On the other hand, the outer peripheral side part 1202 is wound not along the first inner peripheral edge 351 but along only the second to fourth inner peripheral edges 352, 353, and 354 in this order, making it possible to prevent communication characteristics from being deteriorated due to cancelling of magnetic fields. In addition, in the present embodiment, the outer peripheral side part 1202 has a plurality of turns, so that it is possible to sufficiently prevent cancelling of magnetic fields. Further, in the present embodiment, the inner peripheral side part 1201 has a plurality of turns, so that it is possible to enhance coupling to the coupling coil 53 of the IC module 50.

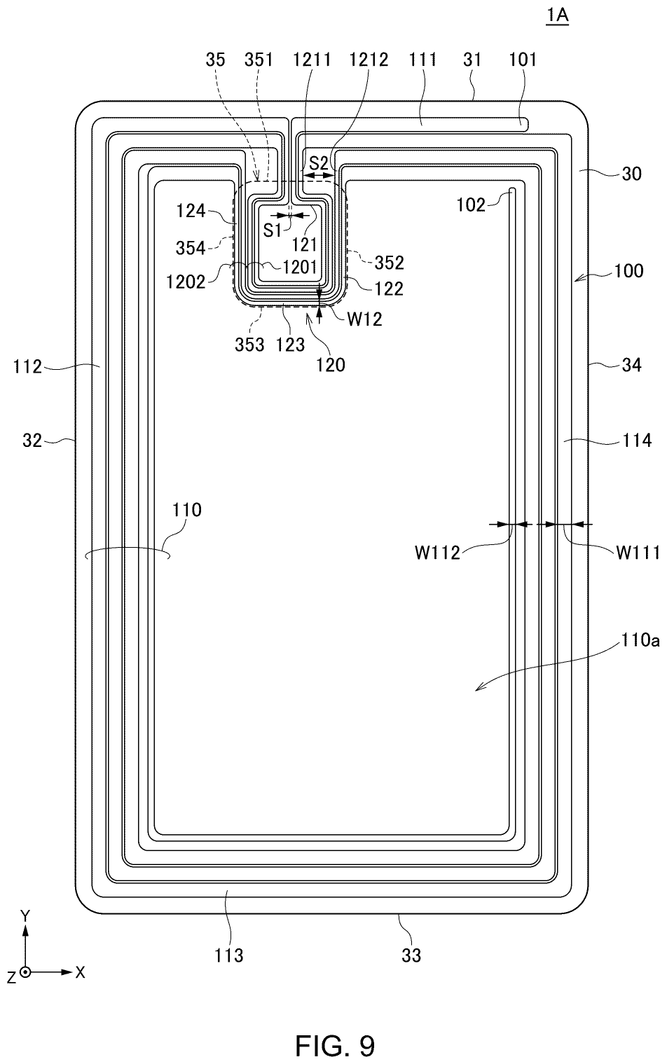

FIG. 9 is a schematic plan view for explaining the configuration of an antenna device 1A according to a first modification of the present embodiment.

As illustrated in FIG. 9, the antenna device 1A according to the first modification of the present embodiment differs from the antenna device 1 according to the above embodiment in that the innermost turn of the first winding part 110 of the coil pattern 100 has a pattern width W112 smaller than a pattern width W111 of other turns of the first winding part 110. Other basic configurations are the same as those of the antenna device 1 according to the above embodiment, so the same reference numerals are given to the same elements, and overlapping description will be omitted.

When the pattern width of the innermost turn of the first winding part 110 is not uniform, the pattern width W112 may be defined by the maximum pattern width, the minimum pattern width, or the average pattern width of the innermost turn of the first winding part 110. Similarly, when the pattern width of other turns than the innermost turn of the first winding part 110 is not uniform, the pattern width W111 may be defined by the maximum pattern width, the minimum pattern width, or the average pattern width of other turns than the innermost turn of the first winding part 110.

When the pattern width W112 of the innermost turn of the first winding part 110 of the coil pattern 100 is selectively made small as in the antenna device 1A according to the first modification, it is possible to adjust the inductance of the coil pattern 100 without significantly changing other parameters. In the first modification, the pattern width W112 of the second, third, and fourth sections 112, 113, and 114 of the innermost turn of the first winding part 110 is made smaller than the pattern width of other turns than the innermost turn of the first winding part 110.

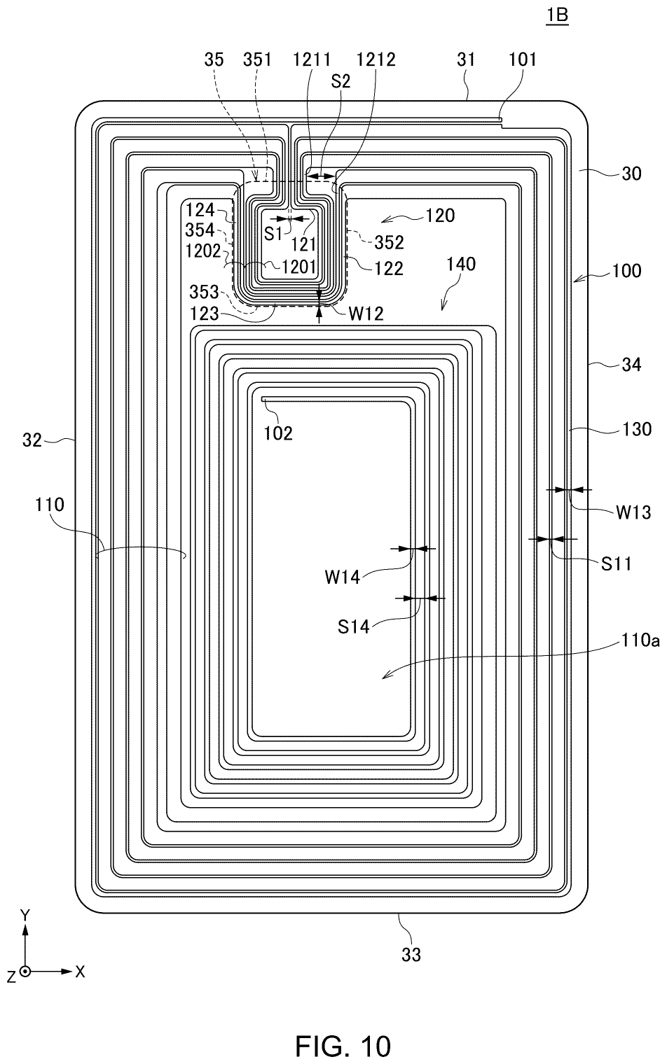

FIG. 10 is a schematic plan view for explaining the configuration of an antenna device 1B according to a second modification of the present embodiment.

As illustrated in FIG. 10, the antenna device 1B according to the second modification of the present embodiment differs from the antenna device 1 according to the above embodiment in that the coil pattern 100 further includes third and fourth winding parts 130 and 140. Other basic configurations are the same as those of the antenna device 1 according to the above embodiment, so the same reference numerals are given to the same elements, and overlapping description will be omitted.

The third winding part 130 is positioned outside the first winding part 110 and wound without passing through the second winding part 120. In the example illustrated in FIG. 10, the third winding part 130 is wound in about one turn. The fourth winding part 140 is positioned inside the first winding part 110 and is wound without passing through the second winding part 120. In the example illustrated in FIG. 10, the fourth winding part 140 is wound in about 5.5 turns.

A pattern width W13 of the third winding part 130 and a pattern width W14 of the fourth winding part 140 are smaller than the pattern width W11 of the first winding part 110. When the pattern width of the third winding part 130 is not uniform, the pattern width W13 may be defined by the maximum pattern width, the minimum pattern width, or the average pattern width of the third winding part 130. Similarly, when the pattern width of the fourth winding part 140 is not uniform, the pattern width W14 may be defined by the maximum pattern width, the minimum pattern width, or the average pattern width of the fourth winding part 140.

The third and fourth winding parts 130 and 140 of the coil pattern 100 mainly act to adjust characteristics such as inductance as well as function as a part of the antenna coil. As in the antenna device 1B according to the second modification, adding the third and fourth winding parts 130 and 140 to the coil pattern 100 can further increase inductance. In addition, the pattern widths W13 and W14 of the third and fourth winding parts 130 and 140 are smaller than the pattern width W11 of the first winding part 110, so that it is possible to sufficiently ensure the numbers of turns of the third and fourth winding parts 130 and 140 while sufficiently ensuring the pattern width W11 of the first winding part 110.

Further, although the third and fourth winding parts 130 and 140 are added to the coil pattern 100 in the example illustrated in FIG. 10, only one thereof may be added. However, when both the third and fourth winding parts 130 and 140 are added to the coil pattern 100, the first and second winding parts 110 and 120 are positioned closer to the center of the line length of the coil pattern 100, so that the density of current flowing in the first and second winding parts 110 and 120 is increased.

Further, in the example illustrated in FIG. 10, a space width S14 between the adjacent turns of the fourth winding part 140 is larger than a space width S11 between the adjacent turns of the first winding part 110. This can adjust the inductance of the coil pattern 100 while sufficiently ensuring the pattern width W1l of the first winding part 110. Further, a parasitic capacitance generated between turns of the fourth winding part 140 can be reduced. When the space width between turns of the fourth winding part 140 is not uniform, the space width S14 may be defined by the maximum space width, the minimum space width, or the average space width between turns of the fourth winding part 140. Similarly, when the space width between turns of the first winding part 110 is not uniform, the space width S11 may be defined by the maximum space width, the minimum space width, or the average space width between turns of the first winding part 110.

Further, in the example illustrated in FIG. 10, the number of turns of the inner peripheral side part 1201 of the second winding part 120 is about three, and the number of turns of the outer peripheral side part 1202 of the second winding part 120 is about two. When the number of turns of the inner peripheral side part 1201 is thus made larger than the number of turns of the outer peripheral side part 1202, coupling between the second winding part 120 and the coupling coil 53 can be enhanced.

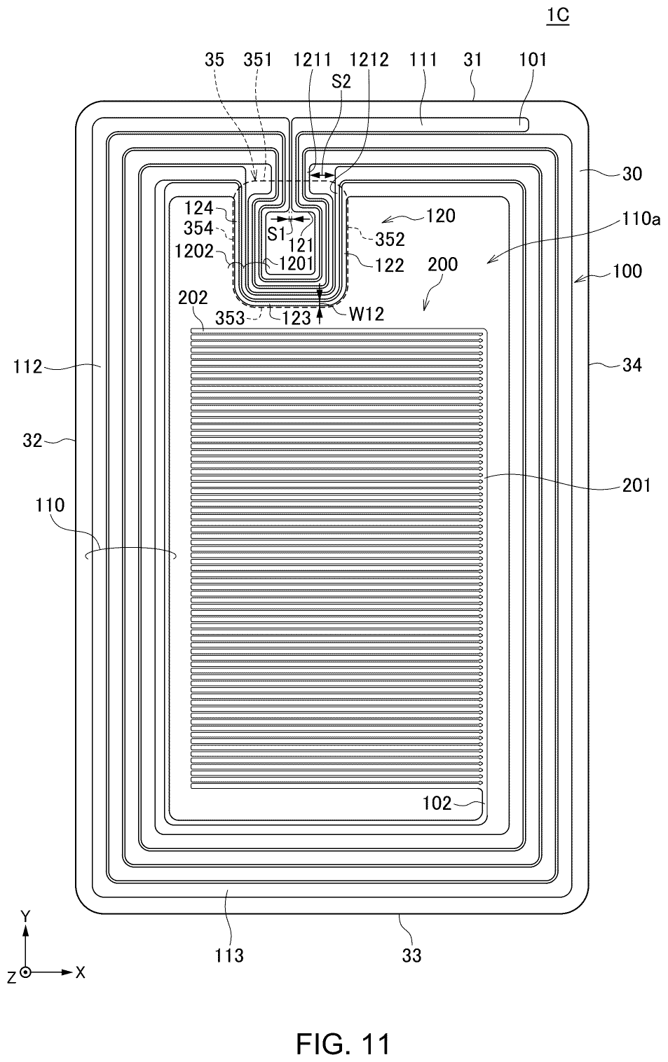

FIG. 11 is a schematic plan view for explaining the configuration of an antenna device 1C according to a third modification of the present embodiment.

As illustrated in FIG. 11, the antenna device 1C according to the third modification of the present embodiment differs from the antenna device 1 according to the above embodiment in that it further has a capacitor electrode pattern 200 connected to the inner peripheral end 102 of the coil pattern 100. Other basic configurations are the same as those of the antenna device 1 according to the above embodiment, so the same reference numerals are given to the same elements, and overlapping description will be omitted.

The capacitor electrode pattern 200 is disposed within the opening 110a of the first winding part 110 and connected to the inner peripheral end 102 of the coil pattern 100. The capacitor electrode pattern 200 has a linear pattern 201 extending in the Y-direction and a plurality of linear patterns 202 branching from the linear pattern 201 and extending in parallel to one another in the X-direction. The linear patterns 202 need not extend strictly in the X-direction. Further, the linear patterns 202 need not extend linearly and may be bent in the middle or may have a meander shape in which the extending direction periodically changes. Furthermore, the plurality of linear patterns 202 need not be strictly parallel to one another. The capacitor electrode pattern 200 is embedded in the adhesive layer 61 as is the case with the coil pattern 100. There is no other conductor pattern between the capacitor electrode pattern 200 and the magnetic body 30 that faces the capacitor electrode pattern 200 through an insulating material. That is, the capacitor electrode pattern 200 overlaps the magnetic body without interposing another conductor pattern therebetween.

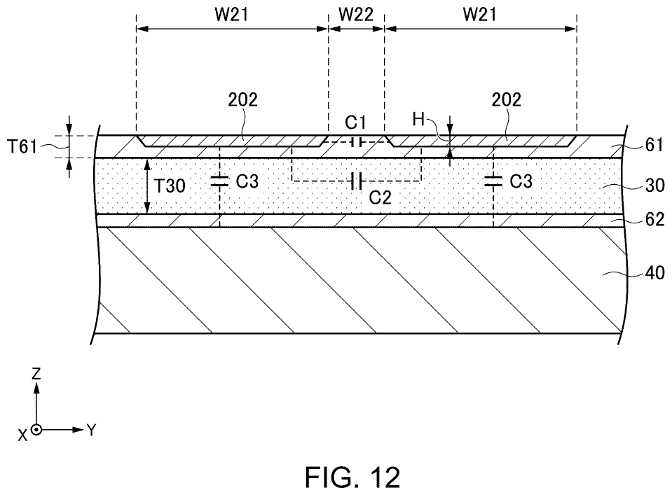

FIG. 12 is a schematic cross-sectional view for explaining a mechanism in which capacitance can be obtained by the capacitor electrode pattern 200.

As illustrated in FIG. 12, although the linear patterns 202 of the capacitor electrode pattern 200 have no opposite electrode in the Z-direction, capacitance is generated between the linear patterns 202 adjacent in the Y-direction. Such capacitance includes not only a component C1 directly generated between the linear patterns 202 adjacent in the Y-direction but also a component C2 generated therebetween through the magnetic body 30. Assuming that the pattern width of one linear pattern 202 in the X-direction is W21 and that the distance between the linear patterns 202 adjacent in the X-direction is W22, W21>W22 is satisfied, indicating that an opposing area between the linear patterns 202 and the magnetic body 30 is sufficiently ensured. A thickness H of the linear pattern 202 in the Z-direction is sufficiently smaller than a distance W22 between the linear patterns 202, so that the directly generated component C1 is very small in amount.

However, the linear patterns 202 overlap the magnetic body 30 through the adhesive layer 61, so that capacitance is enhanced by the component C2 generated through the magnetic body 30. The capacitance component C2 becomes larger as a thickness T61 of the adhesive layer 61 becomes smaller and as the dielectric constant of the adhesive layer 61 becomes higher provided that the dielectric constant of the adhesive layer 61 is lower than the dielectric constant of the magnetic body 30. Therefore, the thickness T61 of the adhesive layer 61 may be smaller than a thickness T30 of the magnetic body 30. The dielectric constant of the magnetic body 30 may be several tens to several hundreds of times the dielectric constant of the adhesive layer 61. For example, when the dielectric constant ε of the adhesive layer 61 is 10 or less, the dielectric constant ε of the magnetic body 30 may be about 1000. As described above, the magnetic body 30 may be a sheet-like member or a coated body coated onto the surface of the adhesive layer 61. In either case, a material prepared by mixing magnetic metal powder containing an Fe—Si—Cr-based alloy magnetic body, an Fe—Si—Al—Cr-based alloy magnetic body, or an Fe—Al—Cr-based alloy magnetic body and binder resin can be used for the magnetic body 30. To increase the component C2, magnetic metal powder contained in the magnetic body 30 may have a flattened shape in the XY plane direction with a small thickness in the Z-direction.

Further, in the present embodiment, the metal plate 40 is provided opposite to the capacitor electrode pattern 200 with respect to the magnetic body 30, whereby a component C3 is generated through the metal plate 40. An electric field to be applied to the adhesive layer 61 and magnetic body 30 functioning as a dielectric forming the component C2 is enhanced by the capacitance component C3 that has been enhanced as a result of suppression of spreading of the electric field by the metal plate 40, and the electric field spreads in the surfaces of the linear patterns 202, thus enhancing the component C2.

Thus, although the linear patterns 202 have no opposite electrode in the Z-direction, they are covered with the magnetic body 30 and metal plate 40 through the adhesive layer 61, so that large capacitance can be achieved by the component C2.

As described above, in the antenna device 1C according to the third modification, the capacitor electrode pattern 200 connected to the inner peripheral end 102 of the coil pattern 100 includes the plurality of linear patterns 202, and the linear patterns 202 are covered with the magnetic body 30 and metal plate 40 through the adhesive layer 61, so that it is possible to achieve large capacitance without requiring an opposite electrode. Thus, it is possible to easily adjust the resonance frequency of the antenna device 1C without increasing the number of turns of the coil pattern, which can prevent characteristic deterioration due to an increase in resistance and an excessive increase in inductance when the number of turns of the coil pattern is increased.

Further, in the antenna device 1C according to the third modification, the y-direction pattern width of the linear pattern 202 extending in the X-direction is reduced at a connection part to the linear pattern 201 extending in the Y-direction. This allows a desired number of linear patterns 202 to be easily separated from the linear pattern 201 by trimming, thus enabling fine adjustment of capacitance.

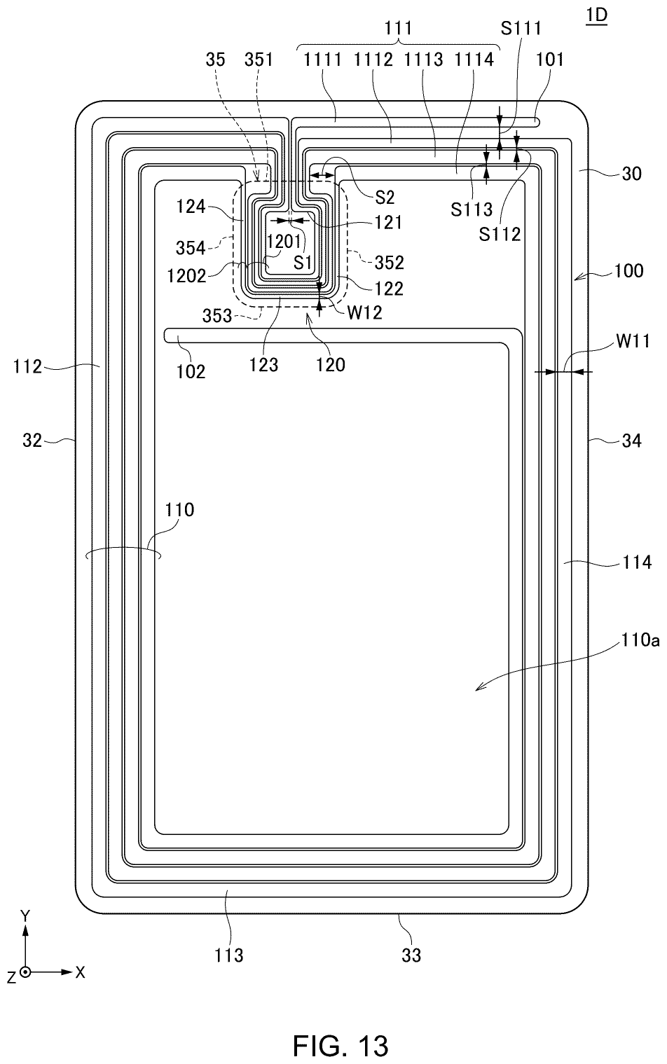

FIG. 13 is a schematic plan view for explaining the configuration of an antenna device 1D according to a fourth modification.

As illustrated in FIG. 13, in the antenna device 1D according to the fourth modification of the present embodiment, the first section 111 of the first winding part 110 of the coil pattern 100 includes four sections 1111 to 1114 from the outer peripheral side toward the inner peripheral side. The section 1111 includes the outer peripheral end 101 of the coil pattern 100. A space width S111 between the radially adjacent sections 1111 and 1112 is larger than a space width S112 between the radially adjacent sections 1112 and 1113 and a space width S113 between the radially adjacent sections 1113 and 1114. Further, in the example illustrated in FIG. 13, the number of turns of the inner peripheral side part 1201 of the second winding part 120 is about three, and the number of turns of the outer peripheral side part 1202 of the second winding part 120 is about one. Other basic configurations are the same as those of the antenna device 1 according to the above embodiment, so the same reference numerals are given to the same elements, and overlapping description will be omitted.

The antenna device 1D according to the present modification is stuck to the plastic plate 10 as is the case with the antenna device 1 according to the above embodiment (see FIG. 3). Here, when the antenna device 1D according to the present modification is stuck to the plastic plate 10, the outer peripheral end 101 of the coil pattern 100 may be shifted from an original position where it should be by pressure upon sticking and may contact the section 1112 in some cases. However, the antenna device 1D according to the present modification is configured such that the space width S111 between the section 1111 including the outer peripheral end 101 and the section 1112 positioned inside thereof is enlarged, so that even when the outer peripheral end 101 is shifted by pressure upon sticking, it is possible to prevent the occurrence of a short-circuit failure between the sections 1111 and 1112. Further, even when the inner peripheral end 102 (or a portion therearound) of the coil pattern 100 is shifted due to pressure upon sticking, a short-circuit failure does not occur because other portions of the coil pattern 100 are absent in a direction (Y-direction) where the inner peripheral end 102 can be shifted due to pressure upon sticking.

Further, as in the antenna device 1D according to the fourth modification, the number of turns of the outer peripheral side part 1202 may be about one.

While the some embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

An antenna device according to an embodiment of the present disclosure includes a magnetic body having a through hole and a coil pattern. The coil pattern includes a first winding part wound in a plurality of turns along the outer edge of the magnetic body and a second winding part connected to respective turns of the first winding part and wound in a plurality of turns in a direction opposite to the winding direction of the first winding part so as to overlap the through hole of the magnetic body. The through hole of the magnetic body includes first and third inner peripheral edges each including a section extending in a first direction and positioned opposite to each other and second and fourth inner peripheral edges each including a section extending in a second direction perpendicular to the first direction and positioned opposite to each other. The second winding part includes an inner peripheral side part wound along the first, second, third, and fourth inner peripheral edges and an outer peripheral side part positioned outside the inner peripheral side part and wound along the second, third, and fourth inner peripheral edges without being along the first inner peripheral edge. With this configuration, it is possible to prevent canceling of magnetic fields at a portion where the first and second winding parts are brought close to each other.

In the above antenna device, the outer peripheral side part of the second winding part may have a plurality of turns. This can prevent more effectively canceling of magnetic fields at a portion where the first and second winding parts are brought close to each other.

In the above antenna device, the inner peripheral side part of the second winding part may have a plurality of turns. This can increase the inductance of the second winding part.

In the above antenna device, the number of turns of the inner peripheral side part may be larger than the number of turns of the outer peripheral side part. This can further increase the inductance of the second winding part.

In the above antenna device, the first and third inner peripheral edges may extend in parallel to each other in the first direction, and the second and fourth inner peripheral edges may extend in parallel to each other in the second direction. This can sufficiently ensure the area of the through hole.

In the above antenna device, the coil pattern further includes a first connection section extending in the second direction and connecting the first winding part and the inner peripheral side part of the second winding part and a second connection section extending in the second direction and connecting the first winding part and the outer peripheral side part of the second winding part. The space width between the first and second connection sections adjacent in the first direction along the first inner peripheral edge of the through hole may be larger than the space width between the first connection sections adjacent in the first direction along the first inner peripheral edge of the through hole. Thus, when the metal plate is put on the magnetic body, interference between a magnetic field around the inner peripheral edge of the through hole of the metal plate and the coil pattern can be reduced.

In the above antenna device, the pattern width of at least a part of the innermost turn of the first winding part may be smaller than the pattern widths of other turns of the first winding part. This can adjust the inductance of the coil pattern without significantly changing other parameters.

In the above antenna device, the coil pattern may further include a third winding part positioned outside the first winding part and wound without passing through the second winding part. This can increase the inductance of the coil pattern. In this case, the pattern width of the third winding part may be smaller than the pattern width of at least a part of the first winding part. This can sufficiently ensure the number of turns of the third winding part while sufficiently ensuring the pattern width of the first winding part.

In the above antenna device, the coil pattern may further include a fourth winding part positioned inside the first winding part and is wound without passing through the second winding part. This can increase the inductance of the coil pattern. In this case, the pattern width of the fourth winding part may be smaller than the pattern width of at least a part of the first winding part. This can sufficiently ensure the number of turns of the fourth winding part while sufficiently ensuring the pattern width of the first winding part. Further, the space width between the turns of the fourth winding part may be larger than the space width between the turns of the first winding part. This can adjust the inductance of the coil pattern while sufficiently ensuring the pattern width of the first winding part.

The above antenna device may further include an adhesive layer for sticking the magnetic body and coil pattern, the coil pattern may have a seed part made of a colored conductive resin material and a metal main body part positioned on the seed part, the seed part may be exposed from the surface of the adhesive layer, and the main body part may be embedded in the adhesive layer without being exposed therefrom. Thus, even if a color change occurs in the main body part, poor appearance becomes visually inconspicuous.

The antenna device may further include a capacitor electrode pattern connected to the inner peripheral end of the coil pattern, and the capacitor electrode pattern may include a plurality of linear patterns extending in parallel to one another. This can adjust the capacitance of the coil pattern. In this case, another conductor pattern that faces the capacitor electrode pattern through an insulating material need not be provided between the capacitor electrode pattern and the magnetic body. This can adjust the capacitance of the coil pattern while reducing manufacturing cost.

In the above antenna device, the space width between a first section including the outer peripheral end of the coil pattern and a second section adjacent to the first section may be larger than the space width between the second section and a third section adjacent to the second section. Thus, even if the outer peripheral end of the coil pattern is shifted slightly, a short-circuit failure between the first and second sections can be prevented.

An IC card according to another embodiment of the present disclosure includes any of the above-described antenna devices and an IC module overlapping the second winding part of the coil pattern through the through hole of the magnetic body. This allows the second winding part of the coil pattern and the IC module to be coupled to each other. In this case, the IC card may further include a metal plate covering the magnetic body from the side opposite the coil pattern, and the metal plate may have a through hole in which the IC module is disposed. With this configuration, there can be provided an IC card using a metal plate as the main body thereof.

What is claimed is:

1. An antenna device comprising:
a magnetic body having a through hole; and
a coil pattern,
wherein the coil pattern includes a first winding part wound in a plurality of turns along an outer edge of the magnetic body and a second winding part connected to respective turns of the first winding part and wound in a plurality of turns in a direction opposite to a winding direction of the first winding part so as to overlap the through hole of the magnetic body,
wherein the through hole of the magnetic body includes first and third inner peripheral edges each including a section extending in a first direction and positioned opposite to each other and second and fourth inner peripheral edges each including a section extending in a second direction perpendicular to the first direction and positioned opposite to each other, and
wherein the second winding part includes an inner peripheral side part wound along the first, second, third, and fourth inner peripheral edges and an outer peripheral side part positioned outside the inner peripheral side part and wound along the second, third, and fourth inner peripheral edges without being along the first inner peripheral edge.

2. The antenna device as claimed in claim 1, wherein the outer peripheral side part of the second winding part has a plurality of turns.

3. The antenna device as claimed in claim 1, wherein the inner peripheral side part of the second winding part has a plurality of turns.

4. The antenna device as claimed in claim 3, wherein a number of turns of the inner peripheral side part is larger than a number of turns of the outer peripheral side part.

5. The antenna device as claimed in claim 1,
wherein the first and third inner peripheral edges extend in parallel to each other in the first direction, and
wherein the second and fourth inner peripheral edges extend in parallel to each other in the second direction.

6. The antenna device as claimed in claim 1,
wherein the coil pattern further includes a first connection section extending in the second direction and connecting the first winding part and the inner peripheral side part of the second winding part and a second connection section extending in the second direction and connecting the first winding part and the outer peripheral side part of the second winding part, and
wherein a space width between the first and second connection sections adjacent in the first direction along the first inner peripheral edge of the through hole is larger than a space width between the first connection sections adjacent in the first direction along the first inner peripheral edge of the through hole.

7. The antenna device as claimed in claim 1, wherein a pattern width of at least a part of an innermost turn of the first winding part is smaller than pattern widths of other turns of the first winding part.

8. The antenna device as claimed in claim 1, wherein the coil pattern further includes a third winding part positioned outside the first winding part and wound without passing through the second winding part.

9. The antenna device as claimed in claim 8, wherein a pattern width of the third winding part is smaller than a pattern width of at least a part of the first winding part.

10. The antenna device as claimed in claim 1, wherein the coil pattern further includes a fourth winding part positioned inside the first winding part and is wound without passing through the second winding part.

11. The antenna device as claimed in claim 10, wherein a pattern width of the fourth winding part is smaller than a pattern width of at least a part of the first winding part.

12. The antenna device as claimed in claim 10, wherein a space width between turns of the fourth winding part is larger than a space width between turns of the first winding part.

13. The antenna device as claimed in claim 1, further comprising a capacitor electrode pattern connected to an inner peripheral end of the coil pattern,
wherein the capacitor electrode pattern includes a plurality of linear patterns extending in parallel to one another.

14. The antenna device as claimed in claim 13, wherein another conductor pattern that faces the capacitor electrode pattern through an insulating material is not provided between the capacitor electrode pattern and the magnetic body.

15. The antenna device as claimed in claim 1, wherein a space width between a first section including an outer peripheral end of the coil pattern and a second section adjacent to the first section is larger than a space width between the second section and a third section adjacent to the second section.

16. The antenna device as claimed in claim 1, further comprising an adhesive layer for sticking the magnetic body and coil pattern,
wherein the coil pattern has a seed part made of a colored conductive resin material and a metal main body part positioned on the seed part,
wherein the seed part is exposed from a surface of the adhesive layer, and
wherein the main body part is embedded in the adhesive layer without being exposed therefrom.

17. An IC card comprising:
an antenna device; and
an IC module,
wherein the antenna device comprising:
a magnetic body having a through hole; and
a coil pattern,
wherein the coil pattern includes a first winding part wound in a plurality of turns along an outer edge of the magnetic body and a second winding part connected to respective turns of the first winding part and wound in a plurality of turns in a direction opposite to a winding direction of the first winding part so as to overlap the through hole of the magnetic body,
wherein the through hole of the magnetic body includes first and third inner peripheral edges each including a section extending in a first direction and positioned opposite to each other and second and fourth inner peripheral edges each including a section extending in a second direction perpendicular to the first direction and positioned opposite to each other,
wherein the second winding part includes an inner peripheral side part wound along the first, second, third, and fourth inner peripheral edges and an outer peripheral side part positioned outside the inner peripheral side part and wound along the second, third, and fourth inner peripheral edges without being along the first inner peripheral edge, and
wherein the IC module overlaps the second winding part of the coil pattern through the through hole of the magnetic body.

18. The IC card as claimed in claim 17, further comprising a metal plate covering the magnetic body from a side opposite the coil pattern,
wherein the metal plate has a through hole in which the IC module is disposed.
